(19) United States
(12) Patent Application Publication
(10) Pub. No.: US 2025/0216337 A1
(43) Pub. Date: Jul. 3, 2025

(54) Light Imaging for Tube Sideseam Inspection

(71) Applicant: Colgate-Palmolive Company, New York, NY (US)

(72) Inventors: Xiaonan ZHANG, Hillsborough, NJ (US); Jun WANG, Fort Washington, PA (US)

(73) Assignee: Colgate-Palmolive Company, New York, NY (US)

(21) Appl. No.: 18/984,121

(22) Filed: Dec. 17, 2024

Related U.S. Application Data
(60) Provisional application No. 63/616,757, filed on Dec. 31, 2023.

(51) Int. Cl. G01N 21/95; G01N 21/59; G06T 7/00

(52) U.S. Cl. CPC G01N 21/95; G01N 21/59; G06T 7/0004

(57) ABSTRACT

A tube seam inspection system is attached to a tube forming device, the tube seam inspection system comprising a light source positioned on one side of a welded seam and an imaging device positioned on an opposing side of the welded sea. The tube seam inspection system is configured to measure the transmittal of light through the welded seam to determine the sufficiency of the seam weld.

### BACKGROUND

Tube containers, such as dispensing tubes, are used to hold and to dispense a wide range of products. These include adhesives, lubricants, lotions, medicants, shampoos, hair dressings, and various oral care products. Such tubes are often formed with plastic materials with or without the use of a metallic layer interposed therein. These tubes are typically formed by folding a sheet of material and sealing an overlapping/contacting region thereof to form a sealed side seam. A problem with such tubes is if the tube side seam is not properly prepared, the seam may be prone to failure. Thus, a need exists for a system and/or method to verify the sufficiency of a tube side seam.

### BRIEF SUMMARY

According to some embodiments, a tube seam inspection system is attached to a tube forming device, the tube seam inspection system comprising a light source positioned on one side of a welded seam and an imaging device positioned on an opposing side of the welded sea. The tube seam inspection system is configured to measure the transmittal of light through the welded seam to determine the sufficiency of the seam weld.

### BRIEF DESCRIPTION OF THE DRAWINGS

FIG. 1 schematically illustrates a tube seam inspection system according to some embodiments.

FIG. 2 shows a perspective view of the tube seam inspection system of FIG. 1.

FIG. 3 shows a cross-sectional view of light being transmitted through a tube seam for use with the tube seam inspection system of FIG. 1.

FIG. 4 shows a perspective view of a shaft of the tube seam inspection system according to some embodiments.

FIG. 5 shows an exploded view of the shaft of FIG. 4.

FIG. 6 shows a partial cross-sectional view of the chassis of the shaft of FIG. 4.

FIG. 7 shows a perspective view of a shaft according to some embodiments.

FIG. 8 shows a side view of the shaft of FIG. 7.

FIG. 9 shows top view of the shaft of FIG. 7.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

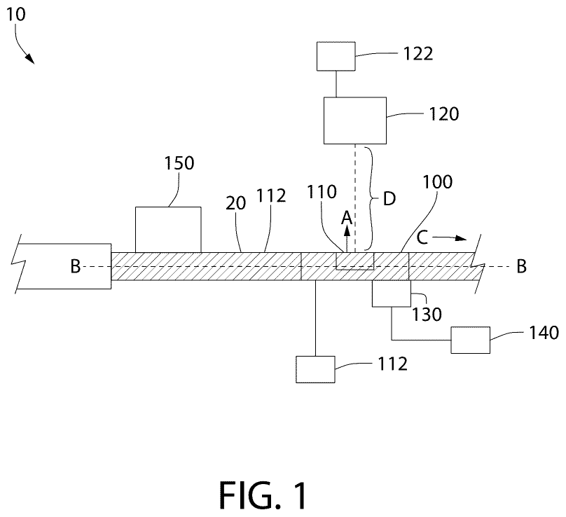

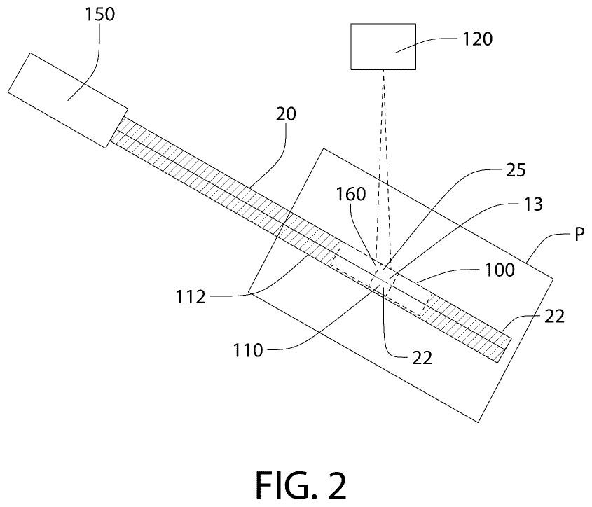

FIGS. 1-2 depict an exemplary tube inspection system 10 according to an embodiment. The tube inspection system 10 comprises a tube shaping shaft 100 equipped with a light source 110. The light source 110 is positioned and oriented to provide a light in a direction A extending perpendicular or substantially perpendicular to a plane P comprising central longitudinal axis B of the tube shaping shaft 100, wherein the plane P may be coincident with a working surface of the tube inspection system. The system 10 further comprises an imaging apparatus such as a camera 120 longitudinally aligned with the light source 110 and separated therefrom by a predetermined distance D. As described in greater detail later on, the imaging apparatus 120 is positioned so that a region 25 of interest is captured by the imaging apparatus, the region 25 being located directly above the light source 110. The light source 120 is coupled to a power source 112, which may be a dedicated power supply, rechargeable battery or non-rechargeable battery. The system 10 further comprises a wireless transmitter 130 which is in communication with a processor 140, e.g., a computer or the like. The light source 110 is configured such that all or substantially all of the light produced by the light source 110 is directed toward a target material 20 located in the region 25.

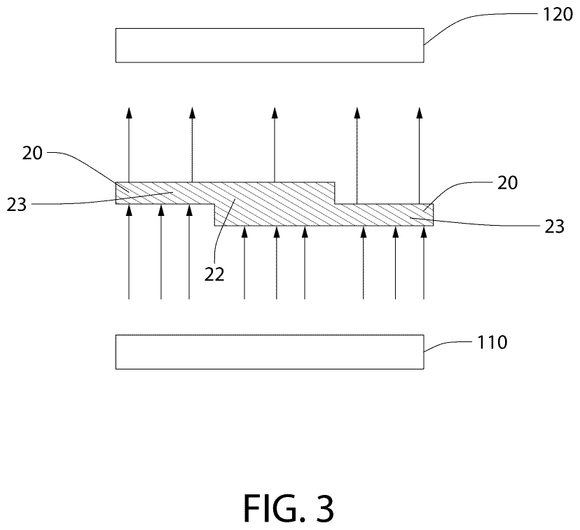

The tube inspection system 10 is configured for attachment to or alternatively is a subcomponent of a system configured to convert a sheet of material into a tube. The system 10, however is not so limited and may be used to one or more sheets of material into a bag, sack, daypack, sachet, container or any other vessel comprising at least one section which is heat-sealed or crimped to secure the one or more sheets of material together. In accordance with one exemplary method, as seen for example in the cross-sectional view of FIG. 3, a continuous sheet of material 20 is loaded onto the tube inspection system 10 and extends along plane P, the sheet of material 20 subsequently being folded over onto itself such that an overlapping seam region 22 is formed. The now-folded sheet of material 20 is then advanced along the system 10 with the overlapping seam region 22 oriented in the direction A such that the overlapping seam region 22 is oriented directly above an upwardly oriented surface 112 (i.e., oriented toward the direction A) of the tube shaping shaft 100. As the overlapping seam region 22 advances along a production line, a welding machine 150 applies a welding force (i.e., in the form of heat) to the seam region 22 to cause the two overlapping layers of the material 20 overlapping at said seam region 22 to at least partially melt or be heated to a sufficient temperature such that the overlapping layers 20 adhere to one another. It is noted that although heat-based welding is described, other welding/attachment means are envisioned within the scope of the invention, including, but not limited to, pressure welding, ultrasound sealing and heat pad sealing. Further down the production line, the sheet of material 20 with the now-welded overlapping seam region 22 may be further welded to form an end seam (not shown) and cut to form a tube. Prior to this step, the exemplary tube inspection system 10 provides a mechanism by which the sufficiency of the weld applied by the welding machine 150 is tested.

As the tube shaping shaft 100 advances the sheet of material 20 forward (i.e., in a direction C), the light source 110 continuously illuminates an underside of the seam region 22 as it advances thereover. Simultaneously, the imaging device 120 which is located directly opposite or substantially directly opposite the light source 110, captures images of the seam region 22 at the location of the light source 110 at a predetermined image capture rate. The image capture rate is selected to ensure that every length of the seam region 22 is captured in an image as it passes region 25 and can be analyzed for seam sufficiency. Alternatively, the image capture rate of the region 25 can be selected to capture only predetermined non-continuous lengths of the seam region 22 or overlapping lengths of the seam region 22 to ensure that the entirety of the seam region 22 is captured.

The exemplary position of the imaging device 120 directly opposite the light source 110 enables the imaging of any light that travels through the seam region 22 at region 25. That is, as light travels through the material 20 at the region 25, it loses its intensity, the loss of intensity being related to a thickness of the material 20 at the seam region 22 and/or a weld sufficiency thereof. For an isotropic material, the light transmittance through the material is expected to be the same along any portion thereof. For an anisotropic material, the light transmittance through the material will vary from location to location. In this example, as light travels through, for example, a uniformly welded seam region 22 at the region 25, the intensity of the light transmitted through said seam region is expected to fall within a predetermined calculated range. The material 20 is considered anisotropic based on the seal conditions, when the light transmittance at the welded seam region 22 is expected to be different from a single layer region 23 located adjacent thereto, as seen for example in FIG. 3. Light transmittal through a welded seam region 22 is lower than light transmittal through the single layer region 23 located adjacent thereto, and furthermore, a uniform quantity of light being transmitted through the seam region is indicative of a uniform and sufficient weld, as shown in FIG. 3. In an exemplary configuration, the wavelength of light being transmitted by the light source 110 is 850 nm or 400-900 nm which covers visible light and near infrared. The wavelength of the light may be slightly longer than that of visible light such that the light is blind to colorant added to the material 20 or to a pattern printed thereonto, light of this wavelength further being highly susceptible to structural changes. In this manner, the tube inspection system 10 is able to detect, via analysis of one or more images of the seam 22 at the region 25, whether the seam 22 comprises a uniform and sufficient weld and is also able to determine whether there are any abnormalities with the weld, thickness of material in the imaged portion of the seam 22, or whether other abnormalities are present (e.g., presence of air or unwanted material in the seam region, etc.). The exemplary tube inspection system 10 enables a non-invasive quality inspection of the seam region 22 while preventing the need to interrupt the tube making process to perform quality checks. The tube inspection system 10 further enables the sensing of any thickness changes, material degradation and detection of cracks in the seam region 22 as the material 20 advances past the light source 110 and imaging device 120.

In an embodiment, the imaging device 120 is separated from the seam 22 by a working distance of 30 mm, although this distance may be varied according to the specific requirements of a particular tube weld. The imaging device 120 is configured to capture up to 60 images per second/3600 images per minute. This rate may be increased or decreased to accommodate, for example, different speeds of movement of the material 20 in the system 10, welding rate of the welding machine 150, etc. For example, the capture rate may be 40 images per second or 40-60 images per second. The imaging device 120 may have a view region 160 that is substantially similar to a length of the light source 110. In one embodiment, the light source 110 has a length L of 100 mm. In another embodiment, the view region 160 may be larger than the length L of the light source 110. A length of the view region 160 may be adjusted by a machine operator by adjusting a lens focal length, as the skilled person would understand. In one embodiment, the imaging device 120 may have a camera lens of 50 mm. although other lens sizes may be implemented according to the requirements of a particular use.

The light source 110 may be configured to provide light in one of a plurality of colors including but not limited to white, yellow, red, orange and blue and/or diffused light in the same colors. The color may be selected to increase sensitivity of the system 10 in detecting deviations in light transmittance and may be selected to conform to, for example, a color of the material 20, a printing color/pattern on the material 20, etc. In an embodiment, the light source 110 may be a 24V, 16 A light emitting diode (LED) bar although other voltage strengths and amperages may be implemented according to the requirements and based on, for example, the color of the material 20, a printing color/pattern on the material 20, etc. These values may be increased for a darker color or thickness of material 20 and lowered for a lighter color and thickness of the material 20. The light source 110 may be coupled to a wireless charging module 145 capable of powering the light source 110 with a constant current.

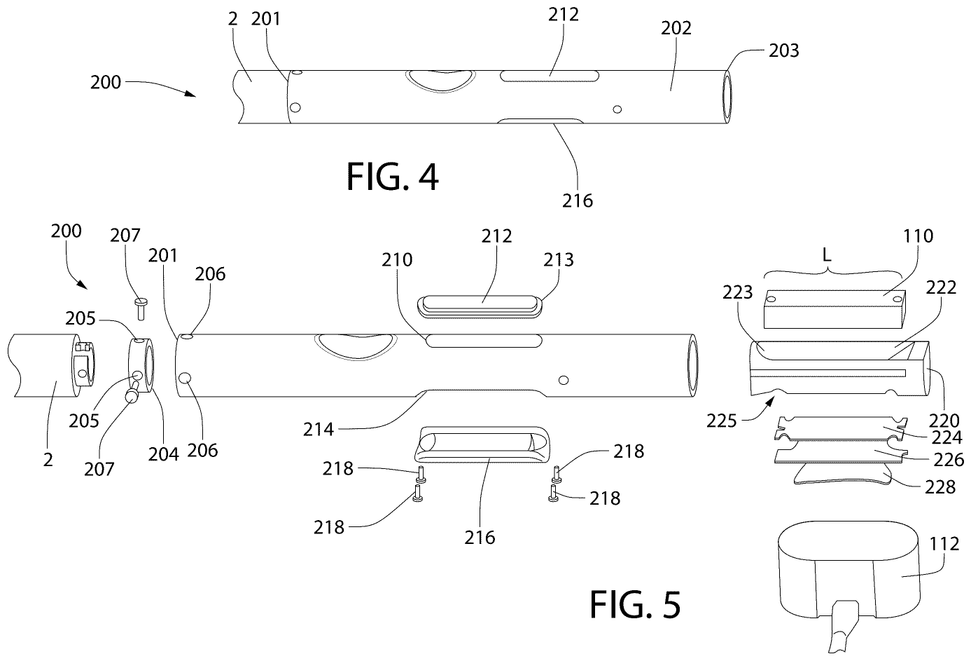

FIGS. 4-6 depict an exemplary shaping shaft 200 according to the invention. The shaft 200 is an elongated tubular member 202 formed of, for example stainless steel or another rigid metal or material, having the light source 110 integrated thereinto. A mounting base 204 is provided at a first end 201 of the shaft 200, the mounting base 204 enabling attachment of the shaping shaft 200 to fixture (e.g., an existing fixture) on a tube forming machine (not shown). The mounting base 204 may be a washer element having screw openings 205 configured to align with openings 206 extending through the shaft 200 adjacent the first end 201. Screws 207 may be inserted through openings 205, 206 to secure the shaft 200 to the fixture on an existing tube forming machine (not shown). Alternatively, the shaping shaft 200 may be secured to the mounting base 204 and the fixture 2 of the tube forming machine via any of washers, bolts, rivets, a snap-fit mechanism or the like. This exemplary configuration allows for retrofitting the system 10 onto existing machinery, thereby reducing costs and enabling the implementation of the side seam inspection device according to the invention without a complete redesign of existing machinery.

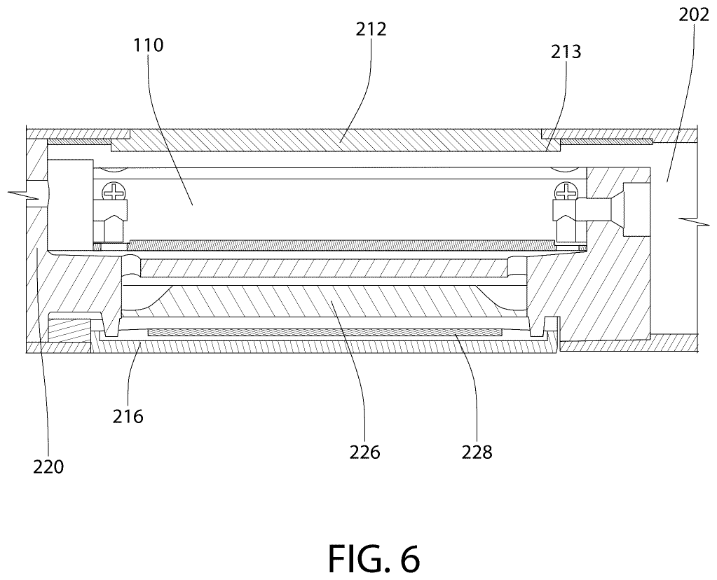

A first opening 210 is formed through a sidewall of the shaft 202, the first opening 210 configured and sized to house a light cover 212 thereover. The light cover 212 may be transparent or substantially transparent and serves to protect the light source 110 while also providing a smooth outer surface for the material 20 to roll therepast during tube assembly. An outer shape of the light cover 212 matches an outer curvature of the shaft 200. The light cover 212 is configured to attach to the shaft 200 via a snap-fit or interference fit. Alternatively, the light cover 212 may be removably secured to the shaft 200 via any known attachment means. The light cover 212 may comprise a bevel 213 extending along an outer perimeter thereof, the bevel 213 defining a reduced-thickness border portion of the light cover 212. An outer profile of the bevel 213 may be greater than dimensions of the opening 210, such that the bevel 213 engages an inner surface of the shaft 202 adjacent the perimeter of the opening 210 to hold the light cover 212 in place, as depicted in the partial cross-sectional view of FIG. 6. Optionally, the inner surface of the shaft 202 adjacent the perimeter of the opening 210 may comprise a respectively sized and shaped rim formed as one of a reduced thickness portion or a protrusion to receive/engage the bevel 213 to maintain a position thereof. The light cover 212 may be held in place via one or more of an adhesive, friction-fit, interlocking, screws or other attachment mechanisms, or any other attachment means known in the art.

A second opening 214 extends through another portion of the shaft 202 diametrically opposed to the first opening 210 and optionally longitudinally aligned therewith. The second opening 214 is configured and sized to house a wireless receiver cover 216 thereover. The wireless receiver cover 216 is configured to be removably attached to the shaft 200 via a plurality of screws 218. Alternatively, the wireless receiver cover 216 may be removably secured to the shaft 200 via a snap-fit, interference fit, or any known attachment means. The light source 110 is secured against rotation within the shaft 200 by insertion thereof into a chassis 220, the chassis 220 having a recess 222 formed therein, the recess 222 being configured to snugly house the light source 110 therewithin. The recess 222 is formed into a first side 223 of the chassis. A second side of the chassis 225 may have a chassis opening (not shown), the chassis opening being smaller than the dimensions of the light source 110 to prevent the light source 110 from moving therepast, the chassis opening being configured to enable electrical attachment of the light source 110 to a PCB 224, first wireless receiver coil 226 and a second wireless receiver coil 228. The assembled chassis 220, with light source 110, PCB 224, first wireless receiver coil 226, and second wireless receiver coil 228 is inserted into a free end 203 of the shaft 202 such that the light source 110 is oriented just below the light cover 212 and the nested first and second wireless receiver coils 226, 228 are oriented just below the wireless receiver cover 216, thus enabling wireless powering of the light source 110 via the wireless power source 112.

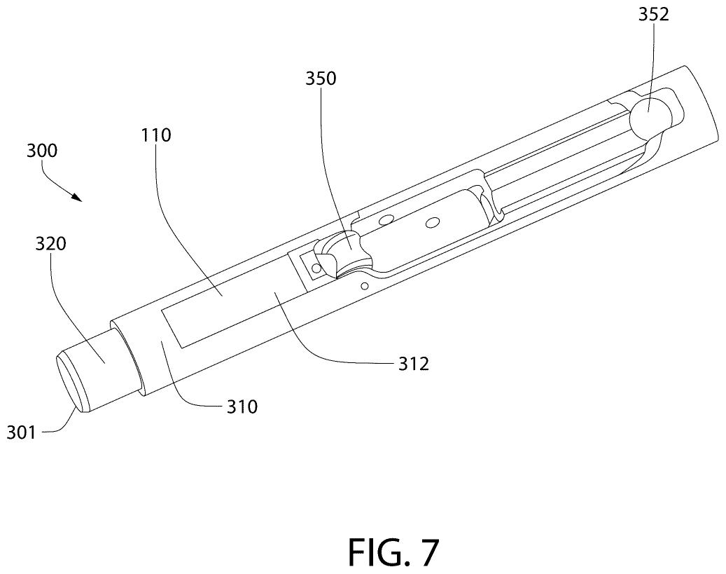

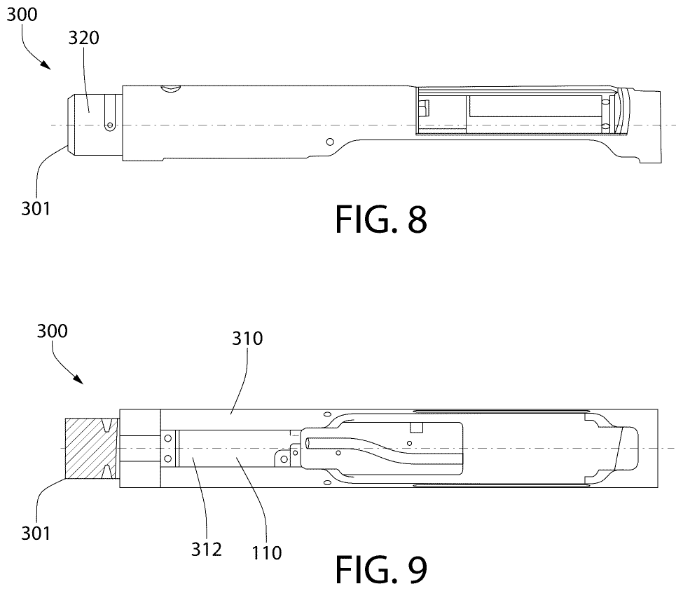

The shaft 200 depicted herein has been shown without the integration of rollers therein for clarity of understanding. FIGS. 7-9 depict a shaft 300 according to an embodiment, the shaft 300 being substantially similar to the shaft 200 except as described below. First, shaft 300 includes rollers 350, 352 therein, the rollers 350, 352 facilitating movement of the material 20 thereover. The rollers 350, 352 are positioned and oriented to not obstruct the light source 110. Light cover 312 of the shaft 300 is not curved in the same manner as light cover 212 but rather, has a planar or substantially planar outer surface to lie flush with a planar side wall 310 of the shaft 300.

Shaft 300 further comprises a reduced thickness portion 320 at first end 301, the reduced thickness section being configured for insertion into a correspondingly sized opening of an existing fixture 2 of a tube forming machine (not shown).

In accordance with an exemplary method according to the invention, a material is loaded onto a tube forming machine fitted with the tube inspection system 10 having shaft 200, 300 or another tube having any combination of features of shafts 200, 300. As a roll of the material 20 is advanced along the tube forming machine, the material 20 is folded and advanced past a welding machine 150 which applies a welding force to portion of the material that is either overlapped or folded with two or more portions of the material positioned adjacent one another, forming the seam 22. The welded roll of material is then advanced over the tube inspection system 10. As the seam 22 moves past the light source 110, the imaging device 120 takes images of the seam. The images are then transmitted to a processor 140 and analyzed to determine the quantity of light being transmitted along each portion of the material 20 and seam 22, as can be understood more clearly with reference to FIG. 3. The processor 140 determines the amount of light transmitted through the material 20 including the seam 22 and determines whether there is consistency in the light transmission pattern as compared to a baseline reference ideal transmission pattern of a sufficiently welded seam. Based on the comparison, the processor 140 determines if the light transmission pattern through the imaged portion of the seam is indicative of a sufficiently welded seam or if there is a deviation detected in the image. If the image indicates a sufficiently welded seam, the material 20 continues down the tube forming machine for optional end seam formation and cutting. If the image indicates a deviation from a sufficiently welded seam, an operator may be alerted via an alarm and the line may be halted to allow for further inspection of the deviation or for removal of the deviated portion. Alternatively, the processor may simply notate which portion of the material indicates a deviation and an operator may inspect/remove said portion from the material further in the tube formation process. The processor 140 may be further configured to provide details of the type of deviation detected (e.g., bump formed in seam, crack in seam, variation in thickness of material, etc.). The processor 140 may control any of 1-4 tube seal inspection systems 10. The processor 140 may be further connected to or comprise an artificial-intelligence assisted module to aid in the analysis of the captured images.

The exemplary tube seal inspection system described herein can be used with any of a tube, bag, sack, daypack, sachet, container or any other vessel configured to house therewithin any of a personal care product, home care product, pet food product or food product in any of a liquid form, gel form, mousse form, paste form, pellet form or solid. Although the tube seal inspection system has been described with respect to the formation of a side-seal of a tube product, the same tube seal inspection system may be used to form any of an end-seam or seal, shoulder seal, zipper-strip seal, or any other seal in at least the above-listed products. The tube seal inspection system may be implemented at any stage in a packaging assembly process, including both prior to and after filling of the package with a product(s). In some embodiments, the tube seal inspection system 10 may comprise a plurality of imaging devices 120 and corresponding number of additional light sources 110 to allow for the simultaneous scanning of multiple seams/seals.

As used throughout, ranges are used as shorthand for describing each and every value that is within the range. Any value within the range can be selected as the terminus of the range. While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A system for imaging a material seam, comprising:
a camera having a lens positioned to image a material seam, the camera being positioned on a first side of the material seam;
a light source for illuminating the material seam, the light source being located on a second side of the material seam opposite the first side; and
a processor configured to determine an intensity of light transmitted through the material seam.

2. The system according to claim 1, wherein, the light source is configured such that substantially all of the light from the light source is oriented toward the material seam.

3. The system according to claim 2, wherein, the light source is enclosed on lateral sides by a side wall configured to prevent light transfer therepast.

4. The system according to claim 1, wherein the processor is further configured to determine, based on the intensity of light transmitted through the seam, one or more of a material degradation of a material forming the tube, a variation in thickness of the tube side seam, a width of the tube side seam and an irregularity in the tube seam.

5. The system according to claim 4, wherein the irregularity may include one or more of a crack, a tear, and an insufficient weld.

6. The system according to claim 1, further comprising a power source.

7. The system according to claim 1, further comprising a wireless transmitter.

8. The system according to claim 1, further comprising a wireless charger.

9. The system according to claim 1, wherein an image length of an image captured by the imaging device is equal to a length of the light source.

10. The system according to claim 1, wherein the imaging device is vertically separated from the seam by a 30 mm.

11. The system according to claim 1, wherein an image length of an image captured by the imaging device is equal to a length of the light source.

12. The system according to claim 1, wherein an image length of an image captured by the imaging device is equal to a length of the light source.

13. The system according to claim 1, further comprising an elongated shaft coupleable to a tube forming device, the elongated shaft housing the light source therein.

14. The system according to claim 12, further comprising a light cover positioned over the light source, the light cover being clear.

15. The system according to claim 12, further comprising a chassis configured to house the light source therein, the chassis configured for insertion into the shaft.

16. The system according to claim 12, further comprising a roller attached to the shaft, the roller configured to aid in movement of the material therepast.

17. The system according to claim 1, wherein the seam is a seam of a tube.

18. A method for inspecting a tube seam, comprising:
providing a light source on a first side of a material having a seam formed therein, the light source being aligned with the seam;
providing an imaging device on a second side of the seam, the second side being located opposite the first side;
capturing an image of the seam as it advances past the imaging device; and
transmitting the image to a processor;
analyzing, by the processor, the amount of light transmitted through the material and the seam.

19. The method of claim 18, further comprising:
comparing, by the processor, the light transmittal data to baseline data correlated with one or more of a sufficiently welded seam, an insufficiently welded side seam, a damaged side seam.
